(19) United States
(12) Patent Application Publication
(10) Pub. No.: US 2010/0266226 A1
(43) Pub. Date: Oct. 21, 2010

(54) BEARING ASSEMBLY WITH A BEARING ELEMENT MADE OF ELTIMID

(75) Inventor: Jorg VOLLMANN-SCHIPPER, Offingen (DE)

Correspondence Address: CANTOR COLBURN, LLP, 20 Church Street, 22nd Floor, Hartford, CT, 06103, US

(73) Assignee: ALBERT HANDTMANN ELTEKA GMBH & CO. KG, Biberach (DE)

(21) Appl. No.: 12/761,909

(22) Filed: Apr. 16, 2010

(30) Foreign Application Priority Data
Apr. 16, 2009 (DE) 10 2009 002 425.5

(51) Int. Cl. F16C 17/00; B23P 17/00; F16C 33/00; F16C 19/00

(52) U.S. Cl. 384/129; 29/898; 384/91; 384/445

(57) ABSTRACT

The present invention relates to a bearing assembly, having at least one first bearing element and a second bearing element being movable relative to the first bearing element, wherein at least one of the bearing elements is made of ELTIMID.

### TECHNICAL FIELD

The present invention relates to a bearing assembly having at least one first bearing element and a second bearing element, being movable with respect to the first bearing element and to a method for the manufacture of such a bearing assembly, as well as the use of ELTIMID for the manufacture of at least one part of such a bearing assembly.

### BACKGROUND

Depending on the intended use, there are various prerequisites for such a bearing assembly, requiring different material properties. Ball bearings are already used for industrial applications of all kinds, which, apart from respective races made of anti-friction bearing steel, have bearing bodies made of a ceramic material (so-called hybrid bearings). They show specific improved properties over rolling bodies made of anti-friction bearing steel. Among technical ceramic materials, e.g. the silicon nitride Si₃N₄ is a material suitable for anti-friction bearings due to its mechanical and physical properties. This material is characterized, among others, by high fraction strength, a low density and a high dielectric strength. These bearings are, e.g., suitable for use in electric machines. Rolling bodies made of ceramic material have a longer service life in comparison to rolling bodies made of steel; they are relatively inured to starved lubrication and are very well suitable for high-speed bearings, since these rolling bodies have a lower density than rolling bodies made of steel.

Further important properties of such bearing elements are their weight, their wear, the resistance to chemically active or aggressive substances, the tensile and compressive strength, the specific electrical resistance, the density and the linear expansion coefficient. Another very important criterion for bearing elements is the manufacturing cost, especially since in bulk products minor price advantages already lead to considerable market advantages.

For certain application purposes of bearing assemblies, it is desirable, also for configurations with no or only very bad lubrication possibilities, to obtain, despite said lubrication problems, sufficiently long service lives; that is to say to nevertheless obtain good wear characteristics with respectively low friction coefficients.

Among the essential properties of respective bearing elements are a low density and hence low mass forces in order to obtain high revolution speeds, a great running smoothness, as possible, good wear characteristics and a small friction coefficient for a resistance-free bearing, as possible.

### BRIEF SUMMARY

According to the invention, at least one of the bearing elements, which form the bearing assembly, is made of ELTIMID. Several or even all parts of the bearing assembly, i.e. the bearing elements, can be made of ELTIMID. The plastic material ELTIMID is manufactured and sold by the company Albert Handtmann Elteka GmbH & Co. KG in Biberach. “ELTIMID” is a registered trademark of the applicant. ELTIMID is a substance which is produced through press forming or moulding a powder which is a non-fusable plastic raw material. Such powder is an aromatic polyimide with the CAS-number 845621-44-5. The CAS Registry Number (CAS=Chemical Abstracts Service) is an international standard of nomenclature for chemical substances and is hence definite. For each known chemical substance, there exists (also biosequences, alloys, polymers), there exists an definite CAS number. Said powder, and, hence, ELTIMID, is therefore registered under such number and therefore identifyable by such number.

The manufacturer of such powder with the CAS number 845621-44-5, the corporation Evonik Industries AG, from which the semi-finished products or the finished bearing assemblies are produced, calls such powder or such raw material, respectively P84 NT1. From such raw material said bearing assemblies, which form the present invention, are produced by press forming or moulding. Those assemblies or semi-finished products are then named ELTIMID and sold to customers who use them for other mechanical applications.

The material ELTIMID has the following characteristics:

Material Characteristics of ELTIMID for DF & HCM parts

| | | | | | Eltimid | | Eltimid | Eltimid |
|---|---|---|---|---|---|---|---|---|
| | | Test | | Eltimid | 15G | Eltimid | 15G | 15M |
| Characteristic | conditions | standard | unit | (DF-part) | (DF-part) | (HCM-part) | (HCM-part) | (HCM-part) |
| Density | | DIN 53479 | g/cm³ | 1.282 | 1.365 | 1.38 | 1.46 | 1.54 |
| Shore D | | DIN 53505 | — | 84 | 83 | 90 | 87 | |
| hardness | | | | | | | | |
| Rockwell | | ISO 2039-2 | RH | R 60 | R 63 | | | |
| hardness | | “R” | | | | | | |
| | | ISO 2039-2 | RH | | | E 94 | | |
| | | “E” | | | | | | |
| Water | 24 h/80° C. | ISO 62 | % | 2.6 | 1.6 | 1.7 | | |
| absorbtion | 48 h/80° C. | | | 3.3 | 2.2 | 2.2 | | |
| | 3 weeks | | | 4.5 | 3.7 | 3.2 | | |
| | 80° C. | | | | | | | |
| Dimensional | | Method Af at | ° C. | 310 | 351 | 325 | | |
| stability | | 1.8 MPa | | | | | | |
| temperature | | Method B at | | 356 | 382 | 373 | 384 | |
| HDT | | 0.45 MPa | | | | | | |
| Glass | 1 Hz | DTMA (main | ° C. | 391.8 | 383.5 | 370 | | |
| transition | | max. of tan δ) | | | | | | |
| temperature T_{G} | | Dynamic | | 325.6 | | 337 | | |
| | | differential | | | | | | |
| | | calometry | | | | | | |
| | | (DDK) | | | | | | |
| Resistance to | Testcyclus:+80° | PV 1200 | % | Ø + 0.2 | Ø + 0.2 | | | |
| atmospheric | C./−40° C. | | | hight + | hight + | | | |
| changes | bei 50 Zyklen | | | 0.6 | 0.4 | | | |

Electrical Characteristics

| | | | | | |
|---|---|---|---|---|---|
| Dielectric | | ISO 60243-1 | kV/mm | 34.4 | 21.8 |
| strength (DC) | | | | | |
| Dielectric loss | 50 Hz | IEC 60250 | — | 3.4 | 4.2 |
| factor | | | | (4*10⁻³) | |
| | 1 kHz | | — | 3.4 | 4.2 |
| | | | | (4*10⁻³) | |
| | 10 kHz | | — | 3.4 | 4.1 |
| | | | | (8*10⁻³) | |
| | 100 kHz | | — | 3.4 | 4.1 |
| | | | | (10*10⁻³) | |
| Surface | | IEC 60093 | Ω | 4.6*10¹⁵ | 5*10¹⁵ |
| Resistivity | | | | | |
| Volume | | IEC 60093 | Ω*m | 1.5*10¹³ | 8*10¹³ |
| Resistivity | | | | | |
| Creep | | IEC 60112 | — | 200 | |
| Resistance | | | | | |
| (CTI) | | | | | |

Mechanical Characteristics

| | | | | | | | | |
|---|---|---|---|---|---|---|---|---|
| Tensile | | ISO 527 | MPa | 74 | 65 | 107 | | 92 |
| Strength | | | | | | | | |
| Elongation | | ISO 527 | % | 3.3 | 2.8 | 3.7 | | 3.2 |
| E-tensile | | ISO 527 | MPa | 3095 | 3939 | 3400 | | 4112 |
| modulus | | | | | | | | |
| Bending | at 23° C. | ISO 178 | MPa | 102 | 91 | 177 | 126 | 146 |
| strength | at 200° C. | | | | | 136 | | |
| Bending | at 23° C. | ISO 178 | % | 3.6 | 2.8 | 6.1 | 3 | 4.6 |
| elongation | at 200° C. | | | | | 8.2 | | |
| E-bending | at 23° C. | ISO 178 | MPa | 2994 | 3577 | 3750 | 4850 | 3788 |
| elongation | at 200° C. | | | | | 3090 | | |
| | at 250° C. | | | 2062 | 2768 | 2300 | | |
| | at 300° C. | | | 1841 | 2542 | 2150 | | |
| Compression | at 1% load | | MPa | | | | | |
| strength | at 10% load | | | 128 | 127 | 105 | 83 | 164 |
| Pressure | | ISO 604 | MPa | 392 | 189 | 470 | 209 | 296 |
| resistance | | | | | | | | |
| E-pressure | | ISO 604 | MPa | 1648 | 1686 | 1960 | 2111 | 2047 |
| modulus | | | | | | | | |
| Pressure | | ISO 604 | % | 59 | 30 | 58 | 23 | 46 |
| Elongation | | | | | | | | |
| Impact | Charpy- | ISO179-1/1eA | kJ/m² | 3.1 | 1.6 | 5.9 | | |
| Resistance | impact | | | | | | | |
| | strength | | | | | | | |
| | Charpy- | ISO179-1/1eU | | 18.3 | 11 | 40 | | |
| | impact | | | | | | | |
| | resistance | | | | | | | |
| Adhesion | v = | ASTM D1894 | μ_{H} | 0.29 | 0.23 | | | |
| Friction factor | 0.0025 m/s; | | | | | | | |
| | hardened | | | | | | | |
| | against | | | | | | | |
| | steel and | | | | | | | |
| | grinded | | | | | | | |
| Slip Friction | v = | ASTM D1894 | μ_{G} | 0.25 | 0.20 | | | |
| factor | 0.0025 m/s; | | | | | | | |
| | hardened | | | | | | | |
| | against | | | | | | | |
| | steel and | | | | | | | |
| | grinded | | | | | | | |

Thermal Characteristics

| | | | | | | | |
|---|---|---|---|---|---|---|---|
| Thermal coef- | 50-200° C. | DIN 53752 | 10⁻⁶/K | 53 | 40 | 54 | 41 |
| ficient of linear | 200-300° C. | | | 66 | 50 | 61 | 45 |
| expansion | | | | | | | |
| Heat capacity | | ISO 527 | J/g*K | 0.98 | 0.97 | 0.925 | 1.046 |
| Heat co- | | ISO 8302 bei | W/m*K | 0.23 | 0.49 | 0.22 | |
| efficient | | 40° C. | | | | | |
| Flammability | | UL 94 | — | V 0 | | | |

The designation 15G means that the material has an addition of 15 wt.-% graphite, the designation 15M means that the material has an addition of 15 wt.-% molybdenum disulphide (MoS₂). Both are additions to the aromatic polyimide with the CAS Number 845621-44-5 and serve as lubricants. A lubrication of the bearing is then no longer necessary as the bearing is then self-lubricating.

The press forming of ELTIMID-parts works generally in two ways: Either by Hot Compression Moulding (HCM) or by Direct Forming (DF). When HCM is used, the powder used is subjected to pressure and temperature but it does not melt, the powder grains rather bake together. A certain time is also needed. It is advisable to use temperatures in the range of 300° C. bis 400° C. and a pressure of between 300 kg/cm² and 500 kg/cm² nd a duration of app. 5-15 hours. When DF is used, the grains of the powder are pressed together under a very high pressure at room temperature, e.g. at 1,0 bis 5,0 t/cm², wherein a kind of sintering, agglomeration or baking takes place. The grain particles hold together through adhesion. ELTIMID therefore is composed of an aromatic polyimide with the CAS number 845621-44-5, which has been hot compression moulded or direct formed, thereby including these powder grains being baked or pressformed together.

The term “bearing element” in this connection relates the various parts of a bearing and a bearing assembly, respectively. They comprise outer rings and inner rings of a radial bearing, bearing shells of an axial bearing, rolling bodies like e.g. balls, needles or the like, cages for rolling bodies, etc. The entire bearing assembly gets more light-weighted since at least one of the two bearing elements, which are movable relatively to each other, is made of ELTIMID having a lower density than anti-friction bearing steel or, for example, ceramic material, like, e.g., silicon nitride (Si₃N₄) which is used for the manufacture of bearings. As a result of the thus reduced mass forces, for example, high speeds of the bearing assembly can be realized.

The invention can advantageously be used as a slide bearing in an embodiment of the bearing assembly. Furthermore, the invention can be perfectly used in large bearing assemblies, like, e.g., the bearing of a conveyor belt or a component or the like. Such a movably supported part will normally be supported on a roller, said roller being located on a respective support bearing and able to roll thereon. Due this more light-weighted design, realized by using ELTIMID for the manufacture of one of the bearing elements, the overall weight of the bearing assembly can be reduced. Such bearings, used in construction, are particularly beneficial in that they are light and low-priced (in comparison to steel) and do not corrode.

A particularly preferred field of application of the present invention comprises the manufacture of anti-friction bearings which are provided with at least one rolling body. Preferably ball bearings, needle bearings, roller bearings or barrel bearings are counted among them. With regard to such bearings, which are produced in large quantities, there is a cost-reducing effect in at least one bearing element being made of ELTIMID.

A special advantage resides in that at least one rolling body made of ELTIMID is provided in the bearing assembly. This can improve the running smoothness of the rolling bodies, especially if all rolling bodies are made of ELTIMID, because both lower density and lower mass forces of the rolling bodies have a positive effect on the running smoothness. This advantage especially influences groove ball bearings which are not run with steel or ceramic balls, but with ELTIMID balls. If the rolling bodies, in particular balls as rolling bodies, are made of ELTIMID, this also produces less material waste than in the manufacture of steel balls—which are manufactured by grinding—since the ELTIMID rolling bodies can be manufactured in a pressing machine. This leads to significant cost savings.

A special field of application of the present invention concerns hybrid bearings in which at least one of the bearing elements is made of steel, ceramic, ELTIMID or a combination thereof. By the combination of different materials, the particular advantages of the individual materials can be combined. For example, the presence of a ball made of ceramic can cause a certain “self-healing” in polluted surroundings. Already one single ceramic ball can free the track from smaller solid impurities by grinding said impurities thanks to its hardness. The remaining balls can, for example, be made of ELTIMID, wherein, for example, the other bearing components are then made of anti-friction bearing steel.

It is much preferred if at least one of the ELTIMID bearing elements has a content of up to 15 wt.-% molybdenum disulfide (MoS₂). This leads to improved wear characteristics and a lower friction coefficient, because said molybdenum disulfide, released by friction, incorporates into the surface of the counter-direction partner—e.g. steel or ceramic—and thereby smoothes a possibly rough surface. That is to say—in other words—the wear is relatively high at first, but decreases strongly with an increasing running period, until the incorporation into the surfaces of the counter-direction partners has reached a saturation level. This effect will be particularly significant, if either an otherwise desired lubrication fails, or a lubrication, e.g. with grease, is not desired, because this will lead to undesired impurities. Possible fields of application are, for example, in food industries or plant engineering.

The effects achieved by adding molybdenum disulfide to ELTIMID can even be enhanced or optimized, if, instead of 15 wt.-%, there are comprised 25 wt.-% or 40 wt.-% of molybdenum disulfide in ELTIMID.

A similarly enhanced lubricating effect can be achieved in that at least one of the ELTIMID bearing elements has a content of 15 wt.-% or 25 to 40 wt.-% of graphite. A suitable combination of the graphite content and the content of molybdenum disulfide might possibly help to optimize the friction and wear properties and, as a result, increase the operating time of a respectively formed bearing element.

The invention also manifests in a novel method for the manufacture of a bearing assembly in that ELTIMID is used as a material for the manufacture of at least one of the bearing elements, like e.g. a bearing shell, bearing bodies or cages for such bearing bodies. Respective bearing elements can then be manufactured by a pressing operation in a press and, unlike steel, need not be produced by cutting processing. The press forces, which—for example—arise or have to be applied in the manufacture of balls, are different and depend on the geometry of the balls. In practice, balls with a diameter of 11.3 mm, for example, could be produced in a press with a pressure of approximately 200 MPa and show a very good quality.

An essential idea underlying the present invention is, not least, based on the fact that ELTIMID is used for the manufacture of at least one part of the bearing assembly. Up to now, it has nowhere been suggested using ELTIMID for the manufacture of a bearing element or even entire bearing assemblies. There are no respective hints or suggestions to have someone skilled in the art use ELTIMID for the manufacture of bearing assemblies or elements thereof.

### BRIEF DESCRIPTION OF THE DRAWINGS

Further advantages, features and characteristics of the present invention are evident from the following description of preferred embodiments of the invention. In the drawing:

FIG. 1 shows a schematic sectional drawing through a first embodiment of the invention in the form of an axial angular ball bearing,

FIG. 2 shows a schematic sectional drawing through a second embodiment of the invention in the form of a radial groove ball bearing,

FIG. 3 shows a schematic sectional drawing through a third embodiment of the invention in the form of a slide bearing, and

FIG. 4 shows a schematic sectional drawing through a forth embodiment of the invention in the form of a bridge bearing.

### DETAILED DESCRIPTION

FIG. 1 depicts an axial angular contact ball bearing 10 with a bearing shell 21 shown on the left and a second bearing shell 24 shown on the right. The two bearing shells 21, 24 are made of anti-friction bearing steel or ball bearing steel and form a ball track 28, in which balls 22 can roll off. The balls 22 are made of ELTIMID having a content of 15 wt.-% molybdenum disulfide. The balls 22 show a density of approximately 1.3 g/cm³, which is considerably less than the one of steel (7.85 g/cm³) and ceramic (3.2 g/cm³). As a result, less mass forces work upon rotation of the axial bearing 10, allowing for high revolution speeds of the bearing. In addition, the running smoothness of such balls is very high. The content of molybdenum disulfide in the balls 22 results, even in case of lubrication failure, in that good running properties of the bearing are maintained over a longer period of time. Molybdenum disulfide, released by the initial abrasion of the balls 22, builds up on the surfaces of the ball track 28 in the bearing shells 21, 24 and causes a low-wear, low-abrasion rolling of the balls 22 on the ball track 28.

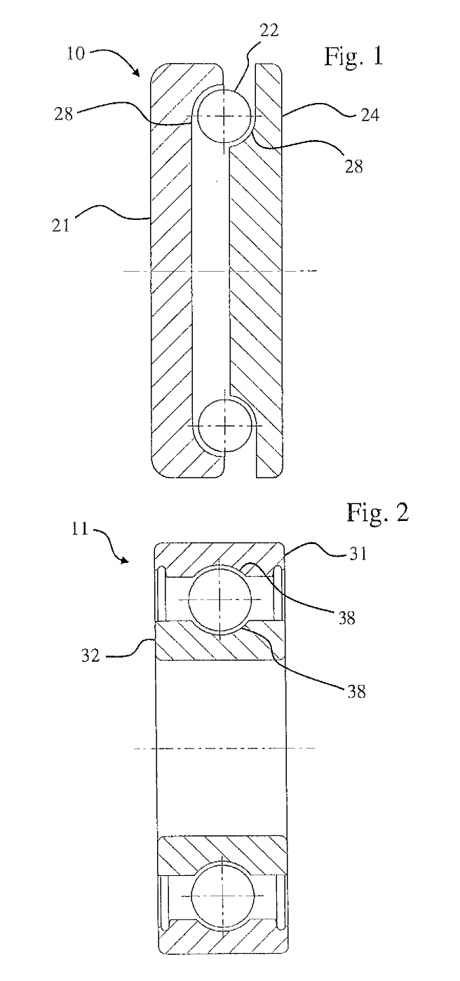

FIG. 2 depicts a radial groove ball bearing 11 with an outer bearing shell 31 and an inner bearing shell 32. The two bearing shells 31, 32 together form a ball track 38 on which the balls 22 can roll. While the outer bearing shell 31 and the balls 22 in this second embodiment are made of anti-friction bearing steel, the inner bearing shell 32 is made of ELTIMID which contains 40 wt.-% of molybdenum disulfide. This radial ball bearing 11 is run without grease lubrication. By rolling off the steel balls 22 on the ball track 38 of the inner bearing shell 32, the latter is initially slightly abraded so that molybdenum disulfide is released. Said molybdenum disulfide builds up on the balls 22 and the ball track 28 of the outer bearing shell 31 and results, after a short period of time, in excellent low-friction and—as a result—low-wear roll characteristics of the balls 22 in the ball track 38.

FIG. 3 depicts a radial slide bearing 12 with an outer slide bearing shell 41 and an inner slide bearing shell 42. The inner slide bearing shell 42 is made of anti-friction bearing steel, whereas the outer slide bearing shell 41 is made of ELTIMID. Said ELTIMID has a content of 15 wt.-% graphite and a content of 15 wt.-% molybdenum disulfide. After an initial abrasion of ELTIMID, the equally abraded weight proportions of graphite and molybdenum disulfide result, after a short period of time, in an optimum lubrication when the outer bearing shell 41 is rotated with respect to the inner bearing shell 42.

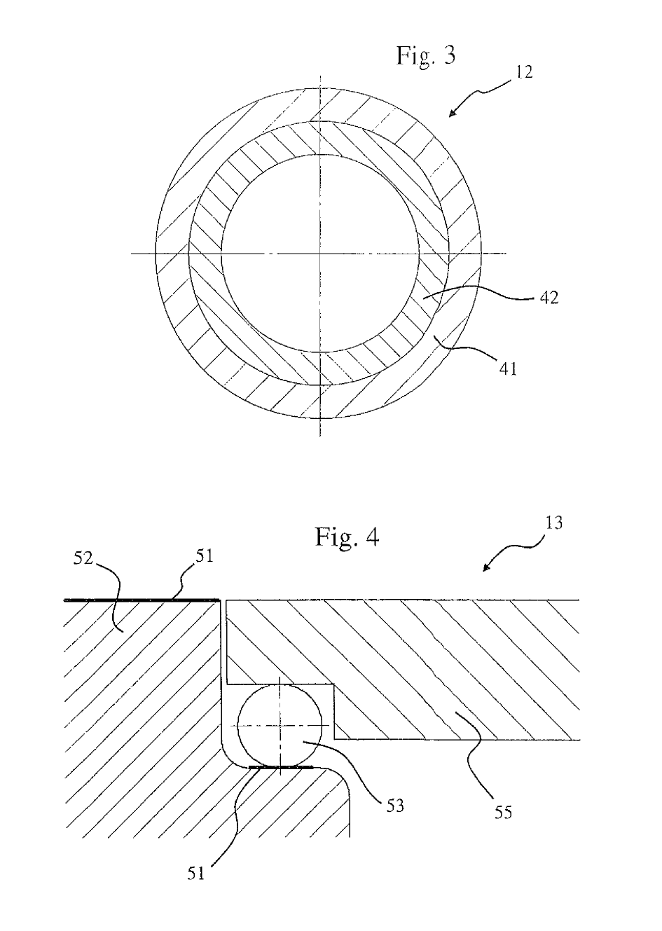

FIG. 4 depicts a bearing assembly 13 for bearing a component 55 on a bearing 52, e.g., the supporting of a pivoting machining table in a machine. On the surface of the bearing 52 is provided a bearing layer 51 which is made of ELTIMID. In said ELTIMID, there may be comprised contents of molybdenum disulfide and/or graphite, so that a lubrication of said bearing assembly 13 by means of grease can be avoided. Between the bearing layer 51 and the component 55, there is provided a roller 53 which is, for example, made of steel. When the component 55 moves to the left or the right, e.g. caused by an elongation or a load applied, the component can roll on the roller 53, thereby setting the roller 53 in a rolling motion which is carried out by the roller 53 on the bearing layer 51. Said bearing assembly 13 is low maintenance, because it needs not be lubricated and—hence—needs also not be relubricated. The assembly can be manufactured at low cost, easily built in and does not corrode.

Graphite has “greasing” properties similar to those of molybdenum disulfide. However, the better adhesion of molybdenum disulfide to metallic surfaces as compared to graphite has to be pointed out. This is due to the secondary valencies of sulphur. However, it has to be stressed in this regard that this is not about free sulphur and its known unpleasant side effects. The sulphur is fixedly bonded in the molybdenum disulphide molecule so that it is under no circumstances released, unless at a decomposition temperature of approximately 450° C. at full access of air.

Another advantage over graphite is that graphite, in general, only shows its lubricating effect at higher temperatures or in a vacuum. One reason is that the bonding of the graphite to metallic surfaces takes place adsorptively with liquid films. Hence, it could be proven that completely degasified graphite has no lubricating effect. Its friction coefficient of approximately 0.1 then increases to values as usual with metals.

Furthermore, molybdenum disulphide is absolutely nontoxic. On the basis of thorough scientific studies and tests, it has been found that molybdenum disulfide is one of the most insoluble compounds at all, which is only affected by chlorine, fluorine, aqua regia and boiling hydrochloric acid or nitric acid. Hence, when using molybdenum disulfide as a lubricant, no special protection measures are needed. The storing of these substances poses no danger.

The material properties of ELTIMID are listed in the following table:

| | | | | |
|---|---|---|---|---|
| | Eltimid ® | Eltimid ® 15G | Eltimid ® | Eltimid ® 15G |
| Property | (DF part) | (DF part) | (HCM part) | (HCM part) |

General Properties

| | | | | |
|---|---|---|---|---|
| Density [g/cm³] | 1.282 | 1.365 | 1.38 | 1.46 |
| Shore D hardness | 84 | 83 | 90 | 87 |
| Rockwell hardness | R 60 | R 63 | | |
| [RH] | | | | |
| Water absorption [%] | 4.5 | 3.7 | 3.2 | |
| 3 weeks at 80° C. | | | | |
| Dimensional stability | 356 | 382 | 373 | 384 |
| temperature HDT | | | | |
| [° C.] at 0.45 MPa | | | | |
| Glass transition tem- | 391.8 | 383.5 | 370 | |
| perature T_{G} [° C.] | | | | |
| Resistance to at- | Ø + 0.2 | Ø + 0.2 | | |
| mospheric changes | height + | height + | | |
| [%] | 0.6 | 0.4 | | |

Electric Properties

| | | |
|---|---|---|
| Dielectric strength | 34.4 | 21.8 |
| (DC) [kV/mm] | | |
| Relative dielectric | 3.4 (4*10⁻³) | 4.2 |
| coefficient (at 50 Hz) | | |
| Specific surface | 4.6*10¹⁵ | 5*10¹⁵ |
| resistance [Ω] | | |
| Specific transition | 1.5*10¹³ | 8*10¹³ |
| resistance [Ω] | | |
| Creep strength | 200 | |

Mechanical Properties

| | | | |
|---|---|---|---|
| Tear strength [MPa] | 74 | 65 | 107 |
| Elongation [%] | 3.3 | 2.8 | 3.7 |
| Tensile modulus of | 3095 | 3939 | 3400 |
| elasticity [MPa] | | | |
| Bending strength at | 102 | 91 | 177 |
| 23° C. [MPa] | | | |
| Bending strain at | 3.6 | 2.8 | 6.1 |
| 23° C. [MPa] | | | |
| Flexural/bending | 2994 | 3577 | 3750 |
| modulus of elasticity | | | |
| at 23° C. [MPa] | | | |

“ELTIMID 15G” is an ELTIMID material with a graphite content of 15%. A “DF part” is a part obtained by direct forming, whereas a “HCM part” is a part which was formed by means of press forming at a higher temperature (Hot Compression Moulding).

ELTIMID is resistant to a plurality of chemicals, like, e.g., gasoline, diesel, motor oil, cooling fluid, antifreeze, brake fluid, sulphuric acid, spirit etc. ELTIMID has an amorphous structure and is equally resistant to high temperatures. ELTIMID also resists continuous use temperatures of up to 260° C. and, for a short time, is resistant to up to 400° C. It has excellent mechanical and tribological properties and—as evident from the above tables—stands out due to its high strength and good ductility, and it is an excellent electric insulator. The resistance to atmospheric changes and the chemical resistance are also outstanding in comparison to a plurality of other plastic materials. In many fields of property, ELTIMID shows values similar to metal, ceramic or silica and therefore is suitable as a substitute for them. Due to the additive molybdenum disulfide, the plastic material additionally achieves the excellent storage properties.

In comparison to anti-friction bearings made of steel or silicon nitride, ELTIMID is characterized by a lower specific electrical resistance and a lower density. Hence, ELTIMID has a specific electrical resistance below 10¹² Ωm and a density below 3.2 g/cm³, namely approximately 1.3 g/cm³.

It has to be stated that the features of the invention, which are mentioned with reference to the depicted and described embodiments, like the kind and the specific design of the individual bearing assemblies, the addition of lubricating components like graphite and molybdenum disulfide, as well as the choice, which one of the bearing elements is made of ELTIMID, can also be present in other embodiments, unless stated otherwise or out of question for technical reasons.

Two preferred embodiments of how to produce parts of ELTIMID are now explained: A preferred Hot Compression Moulding method uses temperatures in the range of 200° C. to 400° C., preferably 280° C. to 380° C., even more preferred about 350° C. A preferred pressure is around 400 kg/cm² and a preferred duration is app. 7-12 hours, even more preferred about 9 hours. When DF is used, the grains of the powder are pressed together under a very high pressure at room temperature, e.g. at 3,0 bis 5,0 t/cm², preferably around 3,5 t/cm². It is advisable to also put such material into a furnance with a temperature of about 300° C. for a period of time of 1 to 10 hours, preferably around 7 hours. These powder grains are then being baked or pressformed together. If lubrication additions such as graphite or molybdenum disulfide are used, these are added in form of a powder prior to press forming the raw powder with the CAS Number 845621-44-5.

1. A bearing assembly comprising at least one bearing element and a second bearing element, movable relative to the first bearing element,
wherein at least one of the bearing elements is made of ELTIMID, a processed aromatic polyimide with the CAS-number 845621-44-5.

2. The bearing assembly according to claim 1,
wherein the bearing assembly is a slide bearing.

3. The bearing assembly according to claim 1,
wherein the bearing assembly is a bearing for an architectural member to be movably seated, a part of a building or the like, resting on at least one roller, which can be rolled off and is located on a support bearing.

4. The bearing assembly according to claim 1,
wherein the bearing assembly is an anti-friction bearing with at least one bearing body.

5. The bearing assembly according to claim 4,
wherein the anti-friction bearing is a ball bearing, a needle bearing, a rolling bearing or a barrel bearing.

6. The bearing assembly according to claim 4,
wherein at least one bearing body is manufactured from ELTIMID.

7. The bearing assembly according to claim 4,
wherein the anti-friction bearing is a hybrid bearing, and wherein at least one of the bearing elements is made of steel or ceramic.

8. The bearing assembly according to claim 1,
wherein the at least one bearing element made of ELTIMID comprises up to 40 wt. % molybdenum disulfide.

9. The bearing assembly according to claim 8,
wherein the at least one bearing element made of ELTIMID comprises up to 25 wt. % molybdenum disulfide.

10. The bearing assembly according to claim 1,
wherein the at least one bearing element made of ELTIMID comprises up to 40 wt. % graphite.

11. The bearing assembly according to claim 10,
wherein the at least one bearing element made of ELTIMID comprises up to 25 wt. %.

12. Method for the manufacture of a bearing assembly according to claim 1,
wherein ELTIMID is used for the manufacture of at least one of the bearing elements.
